(19) United States
(12) Patent Application Publication
(10) Pub. No.: US 2020/0247694 A1
(43) Pub. Date: Aug. 6, 2020

(54) POWER CONTROL APPARATUS AND METHOD

(71) Applicant: AMOSENSE CO.,LTD, Cheonan-si, Chungcheongnam-do (KR)

(72) Inventors: Won-San NA, Seoul (KR); Bo Hyeon HAN, Goyang-si (KR); Jung-Hyun CHOI, Gwangju-si (KR); Jin LEE, Incheon (KR)

(73) Assignee: AMOSENSE CO.,LTD, Cheonan-si, Chungcheongnam-do (KR)

(21) Appl. No.: 16/652,042

(22) PCT Filed: Sep. 18, 2018
(86) PCT No.: PCT/KR2018/010968

§ 371 Date: Mar. 28, 2020

(30) Foreign Application Priority Data
Sep. 29, 2017 (KR) 10-2017-0127000

(51) Int. Cl. C02F 1/461

(52) U.S. Cl. CPC C02F 1/46104; H02M 7/04

(57) ABSTRACT

The present invention relates to a power control apparatus and method for controlling alternating current power at a ratio set according to the concentration and the water quantity of wastewater, and converting the controlled alternating current power into direct current power so as to treat wastewater. A power control apparatus comprises: a power supply unit for outputting alternating current power; a control unit for setting a fixed cycle and a varying cycle on the basis of at least one of the concentration and the water quantity of wastewater so as to output a control signal; a switch unit for controlling the alternating current power output from the power supply unit in the fixed cycle and the varying cycle on the basis of the control signal; and a rectification unit for rectifying the alternating current power controlled by the switch unit.

### TECHNICAL FIELD

The present disclosure relates to a power control apparatus and method, and more particularly, to a power control apparatus and method which treat wastewater by controlling alternating current power at a ratio set according to the concentration and the water quantity of wastewater, and converting the controlled alternating current power into direct current power.

### BACKGROUND ART

At present, Korea has a characteristic that it is difficult to secure water resources due to the severe change in precipitation according to area and season. In addition, groundwater and reservoirs are being contaminated while water consumption is increased, green areas are decreased, and the area of impermeable layers such as concrete and asphalt is increased due to rapid urbanization and industrialization.

Accordingly, by treating and reusing wastewater such as industrial water and agricultural water, a water treatment Electro Coagulation (EC) apparatus is used to decrease contamination of groundwater and reservoirs.

FIG. 1 is a diagram illustrating a wastewater treatment.

Referring to FIG. 1, an Electro Coagulation (EC) apparatus 100 may be used to treat and reuse industrial water, agricultural water, and the like. The EC apparatus 100 may decompose foreign substances in the wastewater by applying direct current power to an electrode contacting the wastewater. Here, the EC 100 apparatus requires the direct current power in order to electrolyze foreign substances in the wastewater. To this end, the EC 100 apparatus may be used after controlling the alternating current power.

The EC 100 apparatus may control the input alternating current power by being turned on and off. That is, the EC 100 apparatus may be turned on or off between the phases of the alternating current power to use a certain amount of power for electrolysis. For example, in the waveform of the alternating current power, the EC 100 apparatus may be switched to ON or OFF at a specific point of the phase between 0 and T. At this time, power may be applied when the EC 100 apparatus is turned on, and power may not be applied when the EC 100 apparatus is turned off. The power which is not applied as the EC 100 apparatus is turned off is not used for the electrolysis as reactive power, thereby decreasing the power factor.

FIG. 2 is a diagram illustrating waveforms of the alternating current power upon a power control of a general EC apparatus.

FIG. 2A illustrates the waveform of the alternating current power which is input to the EC 100 apparatus. The alternating current power which is input to the EC 100 apparatus is high power and may be represented in the form of sine or cosine.

FIG. 2B illustrates the waveform of the controlled alternating current power. The EC 100 apparatus may be turned on or off at a specific point of the phase of the alternating current power and may control the alternating current power. Here, the EC 100 apparatus may be turned off up to a specific point in the phase between 0 and T and then turned on at a specific point, and may use only the alternating current power applied in the turned-on state. At this time, the EC 100 apparatus may have the turned-off phase which become the reactive power in the phase between 0 to T. Accordingly, the EC 100 apparatus may decrease the power factor according to the reactive power.

FIG. 2C illustrates the waveform obtained by rectifying the controlled alternating current power. The EC 100 apparatus may rectify the controlled alternating current power. The EC 100 apparatus may rectify the alternating current power and then convert the rectified alternating current power into the direct current power, thereby using the alternating current power for the electrolysis.

### DISCLOSURE

### Technical Problem

The present disclosure is intended to solve the above problem, and an object of the present disclosure is to provide a power control apparatus and method which treat wastewater without greatly increasing costs.

In addition, another object of the present disclosure is to provide a power control apparatus and method which treat wastewater with low power by increasing a power factor.

In addition to the aforementioned objects of the present disclosure, other features and advantages of the present disclosure will be described below, or will be clearly understood by those skilled in the art from such description and explanation.

### Technical Solution

A power control apparatus according to an embodiment of the present disclosure for achieving the aforementioned objects, as the power control apparatus of a device which electrolyzes a foreign substance in wastewater by using direct current power, includes a power supply unit configured to output alternating current power, a control unit configured to set a fixed cycle and a varying cycle based on one or more of a concentration of wastewater and a water quantity of wastewater, and output a control signal, a switch unit configured to control the alternating current power which is output from the power supply unit in the fixed cycle and the varying cycle based on the control signal, and a rectification unit configured to rectify the alternating current power controlled by the switch unit.

Here, the control unit includes a sensor which measures one or more of the concentration and the water quantity of wastewater.

In addition, the switch unit is turned on or off, at a point where the alternating current power output from the power supply unit is 0V, based on the control signal.

In addition, the switch unit controls the alternating current power, output from the power supply unit, by being turned on during the varying cycle in the fixed cycle.

In addition, the switch unit controls the alternating current power, output from the power supply unit, during the varying cycle every the fixed cycle.

Meanwhile, a power control method according to an embodiment of the present disclosure for achieving the aforementioned objects includes electrolyzing a foreign substance in wastewater by using direct current power and setting a fixed cycle and a varying cycle based on one or more of a concentration and the water quantity of wastewater, controlling an alternating current power output, in the fixed cycle and the varying cycle, and rectifying the alternating current power controlled in the fixed cycle and the varying cycle.

Here, the controlling of the alternating current power output in the fixed cycle and the varying cycle turns on or off the switch unit at a point where the output alternating current power is 0V.

In addition, the controlling of the output alternating current power in the fixed cycle and the varying cycle controls the alternating current power output by turning on the switch unit during the varying cycle in the fixed cycle.

In addition, the controlling of the alternating current power output in the fixed cycle and the varying cycle controls the alternating current power output during the varying cycle every the fixed cycle.

### Advantageous Effects

The power control apparatus and method according to an embodiment of the present disclosure may increase the power factor to decrease the power consumption.

In addition, other features and advantages of the present disclosure may also be newly understood through the embodiments of the present disclosure.

### DESCRIPTION OF DRAWINGS

FIG. 1 is a diagram illustrating a wastewater treatment.

FIG. 2 is a diagram illustrating waveforms of alternating current power upon a power control of a general EC apparatus.

FIG. 3 is a diagram illustrating a configuration of a power control apparatus according to an embodiment of the present disclosure.

FIG. 4 is a diagram illustrating waveforms of power control according to an embodiment of the present disclosure.

FIG. 5 is a diagram illustrating waveforms of the power controlled at different ratios according to the concentration and the water quantity of wastewater.

FIG. 6 is a diagram illustrating a power control method according to an embodiment of the present disclosure.

### MODE FOR INVENTION

Hereinafter, embodiments of the present disclosure will be described in detail with reference to the accompanying drawings so that those skilled in the art to which the present disclosure pertains may easily carry out the present disclosure. The present disclosure may be implemented in various different forms and is not limited to the embodiments described herein.

In order to clearly describe the present disclosure, parts unrelated to the description may be omitted, and the same reference numerals are denoted by the same or like components throughout the specification.

Throughout the specification, when a part is “connected” to another part, this includes not only “directly connected” but also “electrically connected” with another element therebetween. In addition, when a certain part is said to “comprise” or “include” a certain component, this means that it may further include other components, rather than excluding other components unless particularly stated otherwise.

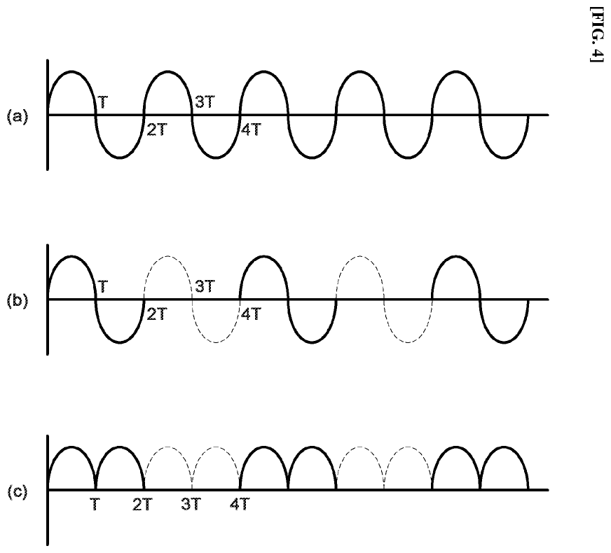

FIG. 3 is a diagram illustrating a configuration of a power control apparatus according to an embodiment of the present disclosure.

Referring to FIG. 3, the power control apparatus according to the embodiment of the present disclosure includes a power supply unit 110, a control unit 120, a switch unit 130, and a rectification unit 140.

The power supply unit 110 outputs alternating current power. Here, the power supply unit 110 may be configured to output the alternating current power generated in an EC apparatus or to receive and output the alternating current power from the outside.

The control unit 120 outputs a control signal by setting a fixed cycle and a varying cycle based on at least one of the concentration and the water quantity of wastewater. Here, the fixed cycle is set to constantly control the alternating current power according to one or more of the concentration and the water quantity of wastewater, and the alternating current power may be controlled at the same ratio every the fixed cycle. In addition, the varying cycle is set to differently control the size of the alternating current power according to one or more of the concentration and the water quantity of wastewater, and the alternating current power may be controlled at a constant ratio every the fixed cycle.

The control unit 120 may include a sensor which measures the concentration and the water quantity of wastewater, and the control unit 120 may set the fixed cycle and the varying cycle according to the concentration and the water quantity of wastewater measured by the sensor. Here, the control unit 120 may set the fixed cycle and the varying cycle, which each match the concentration and the water quantity of pre-stored wastewater. In addition, the control unit 120 may set the fixed cycle and the varying cycle to a fixed cycle and a varying cycle which are input in real time according to the concentration and the water quantity of wastewater.

The switch unit 130 controls the alternating current power, which is output from the power supply unit, in the fixed cycle and the varying cycle based on the control signal of the control unit 120. The switch unit 130 may control the alternating current power by being turned on during the varying cycle in the set fixed cycle. Here, the switch unit 130 may be turned on or off, at a point where the alternating current power output from the power supply unit is 0V, based on the control signal. The switch unit 130 may control the alternating current power by being turned on during the varying cycle in the fixed cycle, and control the alternating current power at the same ratio even in the next repeated fixed cycle.

The rectification unit 140 rectifies the alternating current power controlled during the varying cycle in the fixed cycle in the switch unit 130. Here, the rectification unit 140 may include a diode, and the diode may rectify the alternating current power. The diode may allow current to flow only in one direction, and cut off the current when the current flows in the other direction. The rectification unit 140 may rectify the alternating current power by using this characteristic of the diode. The power control apparatus according to the present disclosure may electrolyze the foreign substances in the wastewater by converting the alternating current power, rectified by the rectification unit 140, into the direct current power through another configuration. Here, the another configuration may be a condenser, a capacitor, or the like for equalizing the rectified alternating current power to the direct current power.

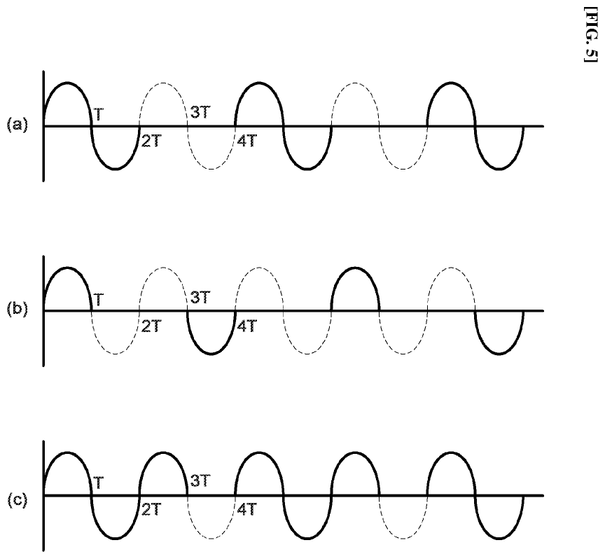

FIG. 4 is a diagram illustrating waveforms of power control according to an embodiment of the present disclosure.

Referring to FIGS. 3 and 4, FIG. 4A illustrates the waveforms of the alternating current power output from the power supply unit 110, and the alternating current power may be represented in the form of sine or cosine. Here, FIG. 4 is described based upon the assumption that the half cycle of the alternating current power is T, but the phase of the alternating current power set to T may be changed.

FIG. 4B illustrates the waveforms of the alternating current power controlled based on the control signal of the control unit 120. Here, the control unit 120 may set the fixed cycle and the varying cycle based on one or more of the concentration and the water quantity of wastewater. The control unit 120 may output the control signal to the switch unit 130 by setting the fixed cycle to 4T and the varying cycle to 2T.

The switch unit 130 may be turned on during 2T which is the varying cycle of the fixed cycle input during 4T by receiving the control signal, and may be turned off during the remaining 2T. That is, the switch unit 130 may be turned on between 0 and 2T and turned off between 2T and 4T, in the phase of the alternating current power. Here, the switch unit 130 may be switched to ON or OFF at the point where the alternating current power becomes 0V. In addition, the switch unit 130 may be turned on during 2T equally even in the next 4T after 4T which is the fixed cycle.

FIG. 4C illustrates the waveforms obtained by rectifying the controlled alternating current power. Since the rectification unit 140 rectifies the alternating current power controlled by the switch unit 130, the rectification unit 140 represents the waveforms which are turned on or off in the same cycle as the controlled alternating current power. That is, the rectification unit 140 may represent the waveform between 0 and 2T of the fixed cycle which is input during 4T, and may not represent the waveform between 2T and 4T.

FIG. 5 is a diagram illustrating the waveform of the power controlled at different ratios according to the concentration and the water quantity of wastewater.

Referring to FIGS. 3 and 5, FIG. 5A illustrates the waveforms of the alternating current power in which the control unit 120 sets the fixed cycle to 4T and the varying cycle to 2T according to one or more of the concentration and the water quantity of wastewater. The switch unit 130 may be turned on during 2T, which is the varying cycle, of the fixed cycle input during 4T based on the control signal of the control unit 120. Thereafter, the switch unit 130 may be turned off during the remaining 2T to maintain a ratio according to one or more of the concentration and the water quantity of wastewater. That is, the control unit 120 may turn on the switch unit 130 between 0 and 2T so that power is applied, and turn off the switch unit 130 between 2T and 4T so that power is not applied.

In addition, the control unit 120 may control the alternating current power equally even in the next fixed cycle after 4T which is the fixed cycle. That is, the control unit 120 may turn on the switch unit 130 between 4T and 6T so that power is applied, and turn off the switch unit 130 between 6T and 8T so that power is not applied. FIG. 5 is described based on the assumption that the half cycle of the alternating current power is T, but the phase of the alternating current power set to T may be changed.

FIG. 5B illustrates the waveforms of the alternating current power in which the control unit 120 sets the fixed cycle to 3T and the varying cycle to T according to one or more of the concentration and the water quantity of wastewater. The switch unit 130 may be turned on during T, which is the varying cycle, of the fixed cycle input during 3T based on the control signal of the control unit 120. Thereafter, the switch unit 130 may be turned off during 2T to maintain a ratio according to one or more of the concentration and the water quantity of wastewater. That is, the control unit 120 may turn on the switch unit 130 between 0 and T so that power is applied, and may turn off the switch unit 130 between T and 3T so that power is not applied.

In addition, the control unit 120 may control the alternating current power equally even in the next fixed cycle after 3T, which is the fixed cycle. That is, the control unit 120 may turn on the switch unit 130 between 3T and 4T so that power is applied, and turn off the switch unit 130 between 4T and 6T so that power is not applied.

FIG. 5C illustrates the waveforms of the alternating current power in which the control unit 120 sets the fixed cycle to 4T and the varying cycle to 3T according to one or more of the concentration and the water quantity of wastewater. The switch unit 130 may be turned on during 3T, which is the varying cycle, of the fixed cycle input during 4T based on the control signal of the control unit 120. Thereafter, the switch unit 130 may be turned off to maintain a ratio according to one or more of the concentration and the water quantity of wastewater. That is, the control unit 120 may turn on the switch unit 130 between 0 and 3T so that power is applied, and turn off the switch unit 130 between 3T and 4T so that power is not applied.

In addition, the control unit 120 may control the alternating current power equally even in the next fixed cycle after 4T, which is the fixed cycle. That is, the control unit 120 may turn on the switch unit 130 between 4T and 7T so that power is applied, and turn off the switch unit 130 between 7T and 8T so that power is not applied.

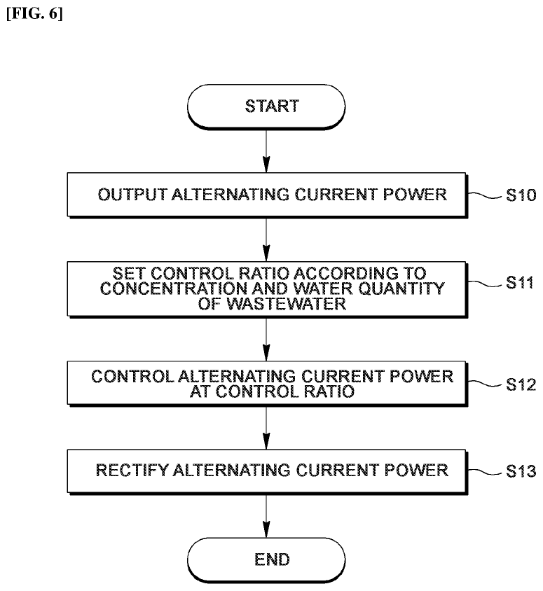

FIG. 6 is a diagram illustrating a power control method according to an embodiment of the present disclosure.

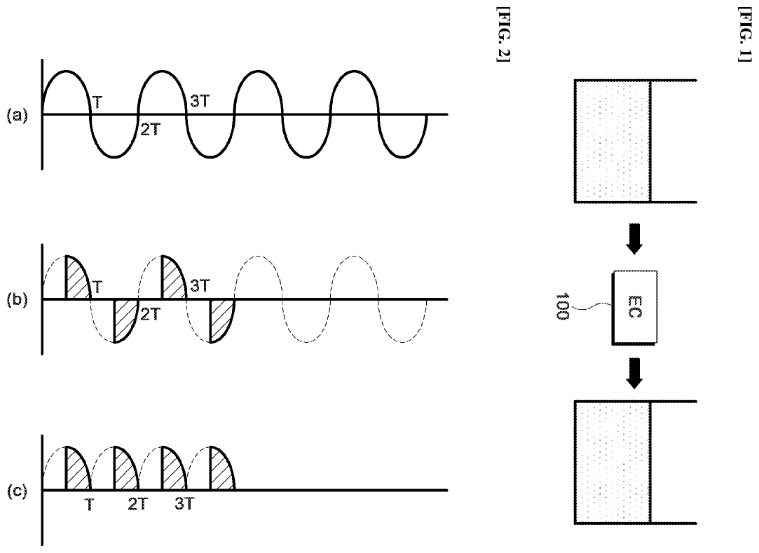

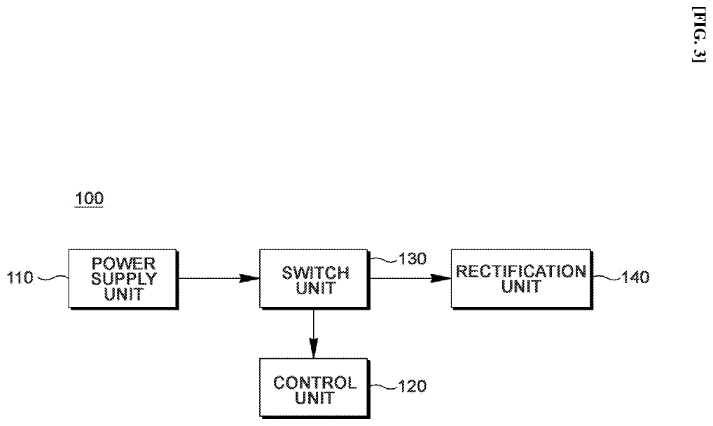

Referring to FIGS. 1 and 3, the power supply unit 110 outputs the alternating current power (S10). Here, foreign substances in the wastewater may be electrolyzed by the direct current power. However, the power supply unit 110 may output the alternating current power, and accordingly, control the alternating current power to convert the alternating current power into the direct current power capable of electrolyzing the foreign substances in the wastewater.

The control ratio is set according to the concentration and the water quantity of wastewater (S11). Here, the control ratio represents the fixed cycle and the varying cycle, and the control ratio may be different according to one or more of the concentration and the water quantity of wastewater. That is, if there are lots of foreign substances in the wastewater, a larger varying cycle may be set in the same fixed cycle so that more power is supplied.

Subsequently, the switch unit 130 controls the alternating current power at the control ratio (S12). The switch unit 130 may control the power by being switched to ON or OFF, at a point where the alternating current power is 0V, according to the control ratio. Here, the EC apparatus is turned on or off between the phases of the alternating current power to generate the reactive power, but the present disclosure may minimize the reactive power because the EC apparatus is turned on or off at the point where the alternating current power is 0V. Accordingly, the power factor may be increased.

Subsequently, the rectifier 140 rectifies the controlled power (S13). The rectifier 140 may rectify the power by using a diode. Since the diode allows current to flow in only one direction, the rectifier 140 may rectify the power due to such a nature.

The present disclosure may realize a power control apparatus and method for controlling the alternating current power at a ratio set according to the concentration and the water quantity of wastewater, and converting the controlled alternating current power to the direct current power to treat the wastewater.

Those skilled in the art to which the present disclosure pertains should be understood that the present disclosure may be carried out in other specific forms without changing the technical spirit or essential features thereof, and thus the aforementioned embodiments are illustrative and not restrictive in all respects. The scope of the present disclosure is defined by the appended claims rather than the detailed description, and all changes or modifications derived from the meaning and scope of the claims and their equivalents should be construed as being included in the scope of the present disclosure.

1. A power control apparatus of a device which electrolyzes a foreign substance in wastewater by using direct current power, the power control apparatus comprising:
a power supply unit configured to output alternating current power;
a control unit configured to set a fixed cycle and a varying cycle based on one or more of a concentration of wastewater and a water quantity of wastewater, and output a control signal;
a switch unit configured to control the alternating current power which is output from the power supply unit in the fixed cycle and the varying cycle based on the control signal; and
a rectification unit configured to rectify the alternating current power controlled by the switch unit.

2. The power control apparatus of claim 1,
wherein the control unit comprises a sensor which measures one or more of the concentration and the water quantity of wastewater.

3. The power control apparatus of claim 1,
wherein the switch unit is turned on or off, at a point where the alternating current power output from the power supply unit is 0V, based on the control signal.

4. The power control apparatus of claim 1,
wherein the switch unit controls the alternating current power, output from the power supply unit, by being turned on during the varying cycle in the fixed cycle.

5. The power control apparatus of claim 1,
wherein the switch unit controls the alternating current power, output from the power supply unit, during the varying cycle every the fixed cycle.

6. A power control method of a power control apparatus of a device which electrolyzes a foreign substance in wastewater by using direct current power, the power control method comprising:
setting a fixed cycle and a varying cycle based on one or more of the concentration and the water quantity of wastewater;
controlling an alternating current power output, in the fixed cycle and the varying cycle; and
rectifying the alternating current power controlled in the fixed cycle and the varying cycle.

7. The power control method of claim 6,
wherein the controlling of the alternating current power output in the fixed cycle and the varying cycle turns on or off a switch unit at a point where the output alternating current power is 0V.

8. The power control method of claim 6,
wherein the controlling of the alternating current power output in the fixed cycle and the varying cycle controls the alternating current power output by turning on a switch unit during the varying cycle in the fixed cycle.

9. The power control method of claim 6,
wherein the controlling of the alternating current power output in the fixed cycle and the varying cycle controls the alternating current power output during the varying cycle every the fixed cycle.
